(19) United States
(12) Patent Application Publication
(10) Pub. No.: US 2018/0367812 A1
(43) Pub. Date: Dec. 20, 2018

(54) ENCODING PERFORMANCE EVALUATION SUPPORT APPARATUS, ENCODING PERFORMANCE EVALUATION SUPPORT METHOD, AND COMPUTER READABLE MEDIUM

(71) Applicant: MITSUBISHI ELECTRIC CORPORATION, Tokyo (JP)

(72) Inventor: Takashi NISHITSUJI, Tokyo (JP)

(73) Assignee: MITSUBISHI ELECTRIC CORPORATION, Tokyo (JP)

(21) Appl. No.: 15/782,017

(22) PCT Filed: Jan. 14, 2016
(86) PCT No.: PCT/JP2016/050931

§ 371 Date: Jun. 6, 2018

(51) Int. Cl. H04N 19/517; H04N 19/57; H04N 19/70

(52) U.S. Cl. CPC H04N 19/517; H04N 19/70; H04N 19/57

(57) ABSTRACT

In an encoding performance evaluation support apparatus (100), an extraction unit (110) extracts a plurality of motion vectors from an encoded video (201). A calculation unit (120) calculates arguments and norms of the plurality of motion vectors extracted by the extraction unit (110). An accumulation unit (140) generates from a calculation result of the calculation unit (120), norm data (301) including one norm for each argument. The accumulation unit (140) accumulates the generated norm data (301) in a memory (105). An output unit (160) outputs information obtained from the norm data (301) accumulated by the accumulation unit (140) and indicating a search range of motion vectors in the encoded video (201).

### TECHNICAL FIELD

The present invention relates to an encoding performance evaluation support apparatus, an encoding performance evaluation support method, and an encoding performance evaluation support program.

### BACKGROUND ART

A moving image captured by a digital camera or the like is encoded for capacity compression to be saved. As an example of an encoding method, there is a method called Moving Picture Experts Group (MPEG)-2 adopted for Digital Versatile Disc (DVD)-Video. There is also an H.264 method adopted for one-segment broadcasting which is terrestrial digital broadcasting for potable terminals, and Blu-ray (registered trademark) Disc (BD). In these encoding methods, a compression method based on motion compensation utilizing similarity between image frames is adopted. An encoded image signal includes motion vectors representing positional relationships of similar points between the frames, and difference values.

As a technique for evaluating encoding performance, there has been proposed a technique for evaluating encoding performance by comparing, from positions referred to by motion vectors as in Patent Literature 1, an image before compression with an image after compression.

When motion vectors are obtained, degree of similarity in pixel block units such as macroblock units is generally calculated using an evaluation function such as a Sum of Absolute Difference (SAD). Then, a point is searched where an encoding amount totalizing encoding amounts of the pixel blocks and encoding amounts of the motion vectors themselves is minimized. Since it is necessary to compute optimal motion vectors for all of the pixel blocks in order to improve encoding efficiency, the search range is broad. Therefore, the calculation amount is enormous which leads to an increase in encoding time.

In order to reduce the calculation load on computation of the motion vectors, there has been proposed and widely used a technique of thinning search points and a search range as in Non-Patent Literature 1.

### CITATION LIST

### Patent Literature

Patent Literature 1: JP 2014-116776 A

### Non-Patent Literature

Non-Patent Literature 1: Rahman, C. A.; Badawy, W., “UMHexagonS Algorithm Based Motion Estimation Architecture for H.264/AVC”, IWSOC '05 Proceedings of the Fifth International Workshop on System-on-Chip for Real-Time Applications, Pages 207-210, IEEE Computer Society Washington, D.C., USA, 2005

### SUMMARY OF INVENTION

### Technical Problem

Even with the technique as in Non-Patent Literature 1, encoding at a video rate is difficult depending on processing capability of the encoder and it is necessary to reduce the calculation load by narrowing down the search range. Therefore, the search range of the motion vectors would be an index for measuring processing performance of the encoder, namely, encoding performance. A manner of thinning search of the motion vectors, namely, search characteristics of the motion vectors would also be an index for measuring encoding performance. A technique for evaluating encoding performance using such indexes has not been proposed so far. In the technique as in Patent Literature 1, complicated image processing is necessary to compare an image before compression with an image after compression.

The encoding performance of an encoder chip is not generally open to public in detail and a technique for quantitatively evaluating the processing performance of the encoder related to motion has not been established so far. The search range and the search characteristics of the motion vectors may be important determination criteria for determining an installation position of a camera or selecting a camera, particularly in a case of capturing motion in a specific direction like a road surveillance camera.

The present invention aims to efficiently obtain an index for quantitatively evaluating encoding performance.

### Solution to Problem

An encoding performance evaluation support apparatus according to one aspect of the present invention includes:

an extraction unit to extract a plurality of motion vectors from an encoded video;

a calculation unit to calculate arguments and norms of the plurality of motion vectors extracted by the extraction unit;

an accumulation unit to generate from a calculation result of the calculation unit, norm data including at least one norm for each argument, and accumulate the generated norm data in a memory; and

an output unit to output at least either of information obtained from the norm data accumulated by the accumulation unit and indicating a search range of motion vectors in the encoded video, and information obtained from the norm data accumulated by the accumulation unit and indicating search characteristics of motion vectors in the encoded video.

### Advantageous Effects of Invention

As described above, a search range and search characteristics of motion vectors would each be an index for quantitatively evaluating encoding performance. In the present invention, there is obtained, from a calculation result of arguments and norms of a plurality of motion vectors included in an encoded video, at least either of information indicating a search range of motion vectors and information indicating search characteristics of motion vectors without requiring complicated image processing. That is, according to the present invention, it is possible to efficiently obtain an index for quantitatively evaluating encoding performance.

### BRIEF DESCRIPTION OF DRAWINGS

FIG. 1 is a block diagram illustrating a configuration of an encoding performance evaluation support apparatus according to a first embodiment.

FIG. 2 is a flowchart illustrating an operation of the encoding performance evaluation support apparatus according to the first embodiment.

FIG. 3 is a block diagram illustrating a configuration of an encoding performance evaluation support apparatus according to a modified example of the first embodiment.

FIG. 4 is a block diagram illustrating a configuration of an encoding performance evaluation support apparatus according to a second embodiment.

FIG. 5 is a flowchart illustrating an operation of the encoding performance evaluation support apparatus according to the second embodiment.

### DESCRIPTION OF EMBODIMENTS

Hereinafter, embodiments of the present invention will be described with reference to drawings. In each of the drawings, the same or corresponding portions are denoted by the same reference signs. In description of the embodiments, description of the same or corresponding portions will be omitted or appropriately simplified.

### First Embodiment

In the present embodiment, a search range of motion vectors is computed from the motion vectors included in a compressed video, as an index for quantitatively evaluating encoding performance.

Hereinafter, a configuration of an apparatus according to the present embodiment, an operation of the apparatus according to the present embodiment, and an effect of the present embodiment will be sequentially described.

***Description of Configuration***

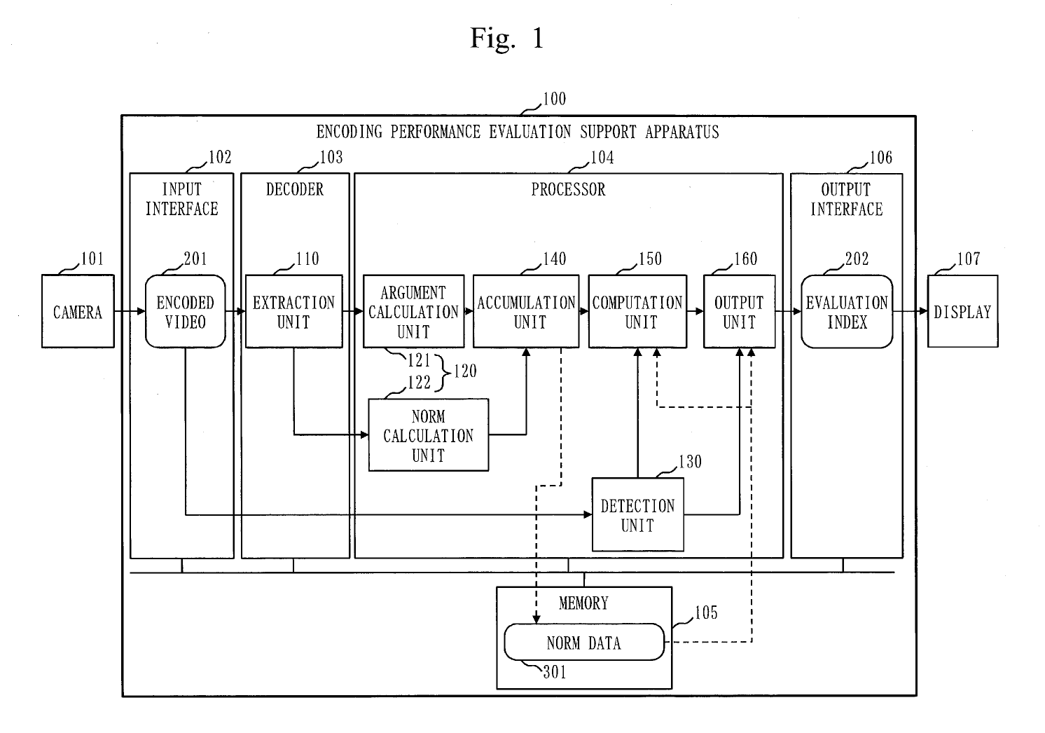

A configuration of an encoding performance evaluation support apparatus 100 being the apparatus according to the present embodiment will be described with reference to FIG. 1.

The encoding performance evaluation support apparatus 100 is a computer.

The encoding performance evaluation support apparatus 100 includes hardware such as an input interface 102, a decoder 103, a processor 104, a memory 105, and an output interface 106. The processor 104 is connected to other hardware via a signal line and controls the other hardware. The input interface 102 is connected to a camera 101. The output interface 106 is connected to a display 107.

The encoding performance evaluation support apparatus 100 includes an extraction unit 110, a calculation unit 120, a detection unit 130, an accumulation unit 140, a computation unit 150, and an output unit 160 as functional elements. The calculation unit 120 includes an argument calculation unit 121 and a norm calculation unit 122. The function of each of the extraction unit 110, the calculation unit 120, the detection unit 130, the accumulation unit 140, the computation unit 150, and the output unit 160, namely, the function of each “unit” is realized by software.

The input interface 102 is a port to which a cable, which is not illustrated, of the camera 101 is connected. Specifically, the input interface 102 is a Universal Serial Bus (USB) terminal or a Local Area Network (LAN) terminal. Specifically, the camera 101 is a digital video camera.

The decoder 103 is a processor for decoding. The decoder 103 may be integrated into the processor 104. That is, the processor 104 may also serve as the decoder 103.

The processor 104 is an Integrated Circuit (IC) which performs processing.

Specifically, the processor 104 is a Central Processing Unit (CPU). Specifically, the memory 105 is a flash memory or a Random Access Memory (RAM).

The output interface 106 is a port to which a cable, which is not illustrated, of the display 107 is connected. Specifically, the output interface 106 is a USB terminal, or a High Definition Multimedia Interface (HDMI (registered trademark)) terminal. Specifically, the display 107 is a Liquid Crystal Display (LCD).

The encoding performance evaluation support apparatus 100 may include a communication device as hardware.

The communication device includes a receiver for receiving data and a transmitter for transmitting data. Specifically, the communication device is a communication chip or a Network Interface Card (NIC).

The memory 105 stores a program for realizing the function of each “unit”. A program for realizing the function of the extraction unit 110 is read into the decoder 103 and executed by the decoder 103. A program for realizing the functions of “units” other than the extraction unit 110 is read into the processor 104 and executed by the processor 104.

The program for realizing the function of each “unit” may be stored in an auxiliary storage device. Specifically, the auxiliary storage device is a flash memory or a Hard Disk Drive (HDD). The program stored in the auxiliary storage device is loaded into the memory 105 and executed by the decoder 103 or the processor 104.

Information, data, signal values and variable values indicating a processing result of each “unit” are stored in the memory 105, the auxiliary storage device, a register or a cache memory in the decoder 103, or a register or a cache memory in the processor 104.

The program for realizing the function of each “unit” may be stored in a portable recording medium such as a magnetic disk or an optical disc.

***Description of Operation***

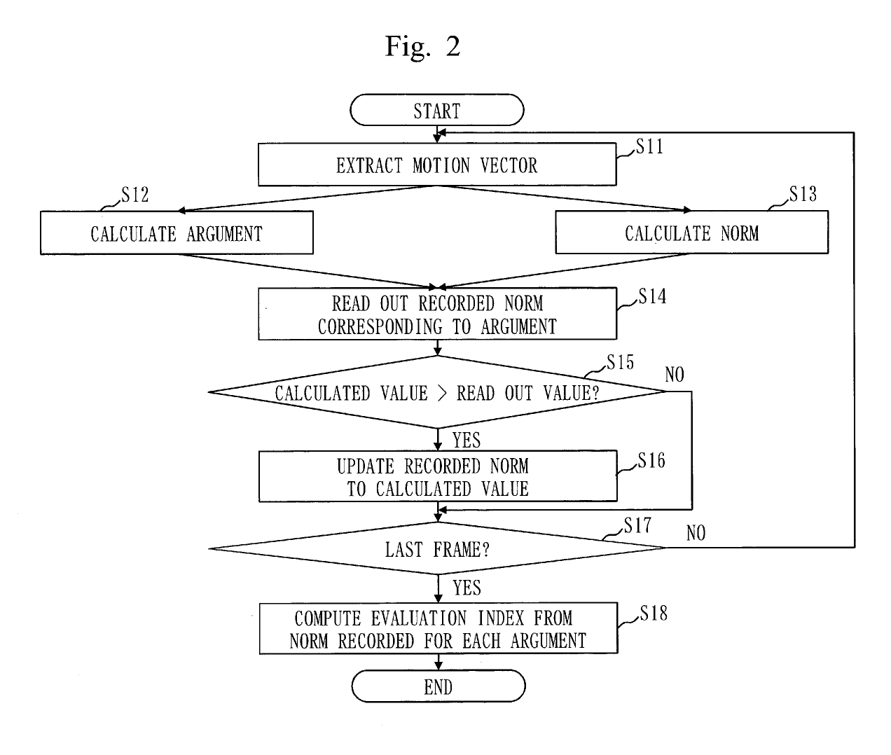

An operation of the encoding performance evaluation support apparatus 100 will be described with reference to FIG. 2. The operation of the encoding performance evaluation support apparatus 100 corresponds to an encoding performance evaluation support method according to the present embodiment. The operation of the encoding performance evaluation support apparatus 100 corresponds to a processing procedure of an encoding performance evaluation support program according to the present embodiment.

In step S11, the extraction unit 110 extracts a plurality of motion vectors from an encoded video 201. Specifically, the extraction unit 110 acquires the motion vectors by decoding the encoded video 201 that is acquired from the camera 101 that captures a video of intense and random motion, and is input via the input interface 102. A video taker holds the camera 101 in his/her hand and pans the camera 101 in such a way that the camera 101 is swung up and down and left and right as well as being rotated, thereby obtaining the “video of intense and random motion”. The extraction unit 110 may partially decode only the motion vectors included in the encoded video 201. Further, the extraction unit 110 may acquire the encoded video 201 wirelessly from the camera 101 or via a recording medium such as a memory card. Each time the extraction unit 110 extracts one motion vector, the extraction unit 110 inputs the extracted motion vector to the argument calculation unit 121 and the norm calculation unit 122.

In steps S12 and S13, the calculation unit 120 calculates arguments and norms of the plurality of motion vectors extracted by the extraction unit 110. Specifically, in step S12, the argument calculation unit 121 calculates an argument component of the input motion vector. The argument calculation unit 121 inputs a calculation result to the accumulation unit 140. In step S13, the norm calculation unit 122 calculates a norm of the input motion vector. The norm calculation unit 122 inputs a calculation result to the accumulation unit 140.

In steps S14 to S17, the accumulation unit 140 generates from a calculation result of the calculation unit 120, norm data 301 including one norm for each argument. The accumulation unit 140 accumulates the generated norm data 301 in the memory 105. Specifically, in step S14, the accumulation unit 140 reads out from the memory 105, a norm which has already been recorded and corresponding to an argument input from the argument calculation unit 121. In step S15, the accumulation unit 140 compares the norm input from the norm calculation unit 122 with the norm read out from the memory 105. In step S16, the accumulation unit 140 records the norm having a larger value in the memory 105, as a norm corresponding to the argument input from the argument calculation unit 121. That is, if the norm calculated in step S13 is larger than the norm read out in step S14, the accumulation unit 140 updates the norm recorded in the memory 105 to the norm calculated in step S13. If the norm calculated in step S13 is smaller than the norm read out in step S14, the accumulation unit 140 does nothing. If the norm corresponding to the argument input from the argument calculation unit 121 has not been recorded in the memory 105 in step S14, step S15 is skipped and the norm input from the norm calculation unit 122 is recorded in the memory 105 in step S16. In step S17, if the detection unit 130 detects that the encoded video 201 has reached the end, the detection unit 130 informs the computation unit 150 about it. If there is no notification from the detection unit 130 to the computation unit 150, the processes of and after step S11 are repeated.

As described above, when arguments of two or more motion vectors calculated by the calculation unit 120 are the same values, the accumulation unit 140 includes, for the same values, any one norm among norms of the two or more motion vectors calculated by the calculation unit 120, in the norm data 301. The “any one norm” is the maximum norm in the present embodiment, but may be the first calculated norm or a norm selected based on other criteria. As in the present embodiment, when the maximum norm is selected among the norms of the two or more motion vectors having common arguments, it is possible to compute a search range of the motion vectors with high accuracy. On the other hand, when the first calculated norm is selected among the norms of the two or more motion vectors, it is possible to compute the search range of the motion vectors with high efficiency since one or some processes can be omitted. Specifically, the processes that can be omitted are each calculation process of a norm in step S13 in a case where a norm corresponding to an argument calculated in step S12 has already been recorded. The processes from steps S14 to S16 can also be omitted.

When an argument of one motion vector calculated by the calculation unit 120 is a different value from an argument of any other motion vector, the accumulation unit 140 includes, for the different value, a norm of the one motion vector calculated by the calculation unit 120, in the norm data 301.

In step S18, the computation unit 150 acquires from the memory 105 the norm data 301 accumulated by the accumulation unit 140. The computation unit 150 computes maximum values of cosine components and sine components of the plurality of motion vectors, using the acquired norm data 301. The output unit 160 outputs a computation result of the computation unit 150, as information indicating the search range of the motion vectors in the encoded video 201. Specifically, for each argument θ, the computation unit 150 firstly reads out from the memory 105 the maximum norm value H recorded in the memory 105 and computes a cosine component B=H·cos θ and a sine component A=H·sin θ. When computation of the cosine components B is completed for all of the arguments θ, the computation unit 150 outputs the maximum value Max(B) from among the computed cosine components B to the output unit 160, as a numerical value indicating the search range of the motion vectors in the x-axis direction. Further, when computation of the sine components A is completed for all of the arguments θ, the computation unit 150 outputs the maximum value Max(A) from among the computed sine components A to the output unit 160, as a numerical value indicating the search range of the motion vectors in the y-axis direction. The output unit 160 displays the numerical values output from the computation unit 150, as an evaluation index 202, on the display 107 via the output interface 106. The output unit 160 may transmit the evaluation index 202 to the outside wiredly or wirelessly or may write the evaluation index 202 in a recording medium such as a memory card.

As described above, the output unit 160 outputs the information obtained from the norm data 301 accumulated by the accumulation unit 140 and indicating the search range of the motion vectors in the encoded video 201, specifically, the information indicating the search range computed from the norm data 301 accumulated by the accumulation unit 140. It is possible to quantitatively evaluate encoding performance by using this information.

***Description of Effect of Embodiment***

In the present embodiment, there is obtained, from the calculation result of the arguments and norms of the plurality of motion vectors included in the encoded video 201, the information indicating the search range of the motion vectors without requiring complicated image processing. That is, according to the present embodiment, it is possible to efficiently obtain the evaluation index 202 for quantitatively evaluating encoding performance.

In the present embodiment, computation of the evaluation index 202 can be realized in four steps of (1) capturing a video of intense and random motion, (2) encoding by an encoder to be evaluated, (3) extracting motion vector information from the encoded video 201, and (4) aggregating the maximum value of motion vector norms for each argument. A large number of motion vectors each having a large norm are generated in various directions in the encoded video 201 obtained by encoding the video of intense and random motion. The maximum norm length of these motion vectors is determined by a motion vector search range prescribed for each encoder. Therefore, it is possible to determine the motion vector search range of the encoder by aggregating the maximum value of motion vector norms for each argument. That is, it is possible to realize quantitative evaluation of processing performance of the encoder related to motion. In addition, it is possible to shorten time required for encoding performance evaluation because of simplicity of processing.

***Other Configuration***

In the present embodiment, the function of each “unit” is realized by software, but as a modified example, the function of each “unit” may be realized by hardware. For the modified example, a difference from the present embodiment will be mainly described.

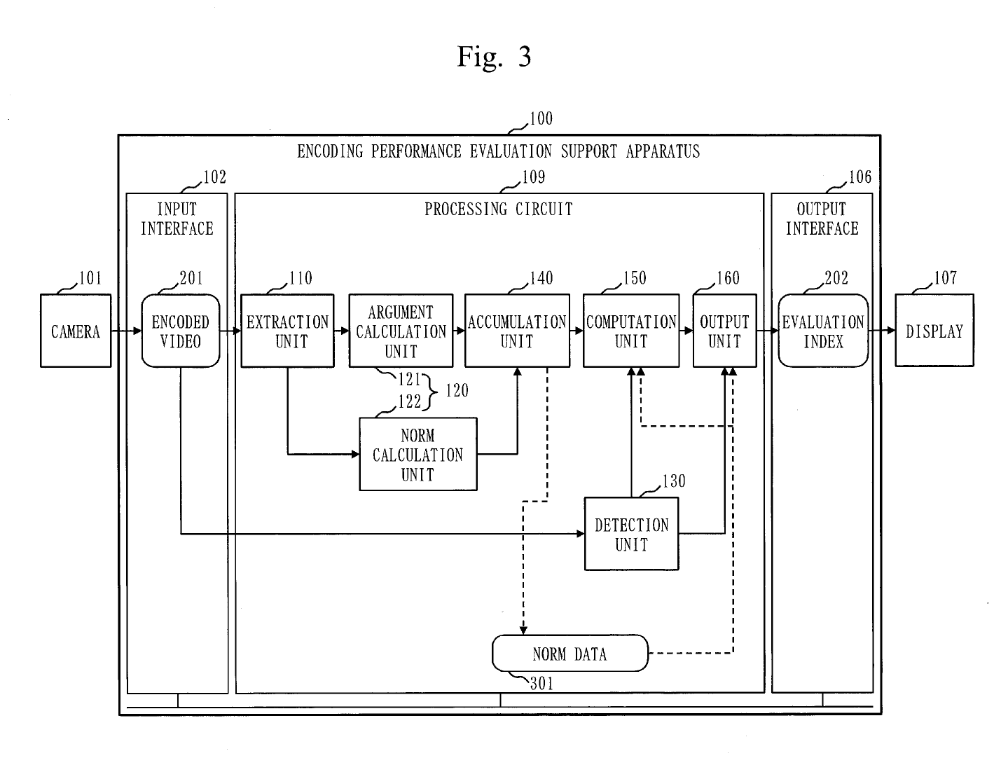

A configuration of an encoding performance evaluation support apparatus 100 according to the modified example of the present embodiment will be described with reference to FIG. 3.

The encoding performance evaluation support apparatus 100 includes hardware such as a processing circuit 109, an input interface 102, and an output interface 106.

The processing circuit 109 is a dedicated electronic circuit for realizing the function of each “unit” described above. Specifically, the processing circuit 109 is a single circuit, a composite circuit, a programmed processor, a parallel programmed processor, a logic IC, a Gate Array (GA), an Application Specific Integrated Circuit (ASIC), or a Field-Programmable Gate Array (FPGA).

The function of each “unit” may be realized by one processing circuit 109 or may be dispersedly realized by a plurality of processing circuits 109.

As another modified example, the function of each “unit” may be realized by a combination of software and hardware. That is, one or some functions of the “units” may be realized by dedicated hardware and the remaining functions may be realized by software.

The decoder 103, the processor 104, the memory 105, and the processing circuit 109 are collectively referred to as “processing circuitry”. That is, even when the configuration of the encoding performance evaluation support apparatus 100 is a configuration as illustrated in any of FIGS. 1 and 3, the function of each “unit” may be realized by the processing circuitry.

Each “unit” may be replaced with “step”, “procedure” or “process”.

### Second Embodiment

In the present embodiment, data indicating search characteristics of motion vectors is generated from the motion vectors included in a compressed video, as an index for quantitatively evaluating encoding performance.

Hereinafter, a configuration of an apparatus according to the present embodiment, an operation of the apparatus according to the present embodiment, and an effect of the present embodiment will be sequentially described. A difference from the first embodiment will be mainly described.

***Description of Configuration***

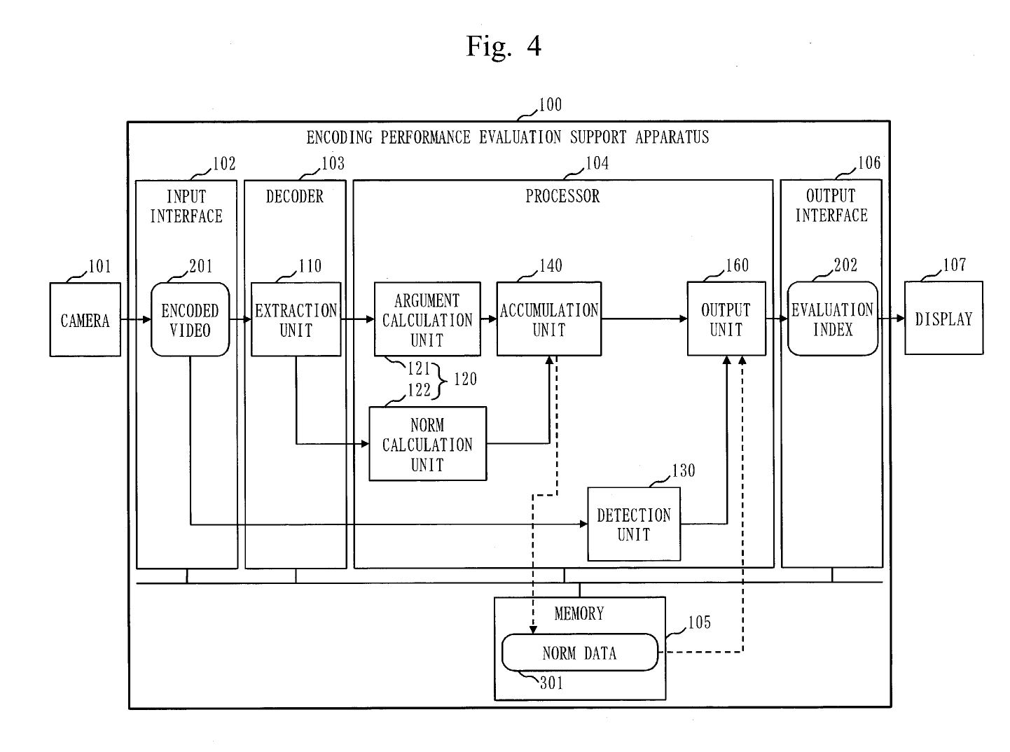

A configuration of an encoding performance evaluation support apparatus 100 being the apparatus according to the present embodiment will be described with reference to FIG. 4.

As in the first embodiment, the encoding performance evaluation support apparatus 100 is a computer.

In the present embodiment, the encoding performance evaluation support apparatus 100 includes an extraction unit 110, a calculation unit 120, a detection unit 130, an accumulation unit 140, and an output unit 160 as functional elements. That is, the encoding performance evaluation support apparatus 100 does not include a computation unit 150 in the present embodiment.

***Description of Operation***

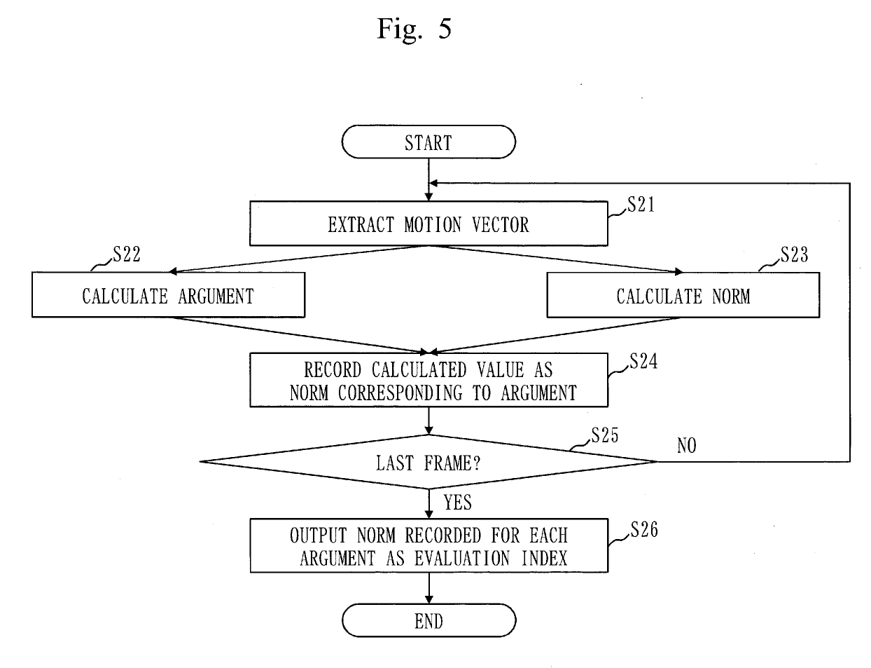

An operation of the encoding performance evaluation support apparatus 100 will be described with reference to FIG. 5. The operation of the encoding performance evaluation support apparatus 100 corresponds to an encoding performance evaluation support method according to the present embodiment. The operation of the encoding performance evaluation support apparatus 100 corresponds to a processing procedure of an encoding performance evaluation support program according to the present embodiment.

Since steps S21 to S23 are the same as steps S11 to S13 in the first embodiment, descriptions thereof are omitted.

In steps S24 and S25, the accumulation unit 140 generates from a calculation result of the calculation unit 120, norm data 301 including at least one norm for each argument. The accumulation unit 140 accumulates the generated norm data 301 in a memory 105. Specifically, in step S24, the accumulation unit 140 records a norm input from a norm calculation unit 122 in the memory 105, as a norm corresponding to an argument input from an argument calculation unit 121. In step S25, if the detection unit 130 detects that an encoded video 201 has reached the end, the detection unit 130 informs the output unit 160 about it. If there is no notification form the detection unit 130 to the output unit 160, the processes of and after step S21 are repeated.

As described above, when arguments of two or more motion vectors calculated by the calculation unit 120 are the same values, the accumulation unit 140 includes, for the same values, all norms among norms of the two or more motion vectors calculated by the calculation unit 120, in the norm data 301. A threshold number may be set in advance and more norms than the threshold number may be excluded from the norm data 301. As in the present embodiment, when all the norms are included among the norms of the two or more motion vectors having common arguments, it is possible to generate the norm data 301 accurately indicating search characteristics of the motion vectors. On the other hand, when only as many first calculated norms as the threshold number or fewer first calculated norms than the threshold number are included among the norms of the two or more motion vectors, it is possible to generate the norm data 301 indicating the search characteristics of the motion vectors in a short time since one or some processes can be omitted. Specifically, the processes that can be omitted are each calculation process of a norm in step S23 in a case where as many norms as the threshold number corresponding to an argument calculated in step S22 have already been recorded.

When an argument of one motion vector calculated by the calculation unit 120 is a different value from an argument of any other motion vector, the accumulation unit 140 includes, for the different value, a norm of the one motion vector calculated by the calculation unit 120, in the norm data 301.

In step S26, the output unit 160 outputs the norm data 301 accumulated by the accumulation unit 140, as information indicating the search characteristics. Specifically, for each argument, the output unit 160 reads out from the memory 105 all the norms recorded in the memory 105 and displays the read out norms as an evaluation index 202 on a display 107 via an output interface 106. The output unit 160 may transmit the evaluation index 202 to the outside wiredly or wirelessly or may write the evaluation index 202 in a recording medium such as a memory card.

As described above, the output unit 160 outputs the information obtained from the norm data 301 accumulated by the accumulation unit 140 and indicating the search characteristics of the motion vectors in the encoded video 201, specifically, the information indicating the search characteristics represented by the norm data 301 accumulated by the accumulation unit 140. It is possible to quantitatively evaluate encoding performance by using this information. Specifically, it is possible to evaluate encoding performance by computing the occurrence frequency of the norms from the norm data 301 and determining the search characteristics of the motion vectors.

***Description of Effect of Embodiment***

In the present embodiment, there is obtained, from the calculation result of the arguments and norms of the plurality of motion vectors included in the encoded video 201, the information indicating the search characteristics of the motion vectors without requiring complicated image processing. That is, according to the present embodiment, it is possible to efficiently obtain the evaluation index 202 for quantitatively evaluating encoding performance.

According to the present embodiment, as in the first embodiment, it is possible to realize quantitative evaluation of processing performance of an encoder related to motion. Specifically, it is possible to evaluate characteristics relating to a motion vector search, from the occurrence frequency of motion vector norms that may be generated, for each norm length. In addition, it is possible to shorten time required for encoding performance evaluation because of simplicity of processing.

***Other Configuration***

In the present embodiment, the configuration of the encoding performance evaluation support apparatus 100 may be changed to the same configuration as in the first embodiment, and the same operation as in the first embodiment may be added to the operation of the encoding performance evaluation support apparatus 100. That is, the output unit 160 may output both of information obtained from the norm data 301 accumulated by the accumulation unit 140 and indicating a search range of the motion vectors in the encoded video 201, and information obtained from the norm data 301 accumulated by the accumulation unit 140 and indicating the search characteristics of the motion vectors in the encoded video 201.

In the present embodiment, the function of each “unit” is realized by software as in the first embodiment, but the function of each “unit” may be realized by hardware as in the modified example of the first embodiment. Alternatively, the function of each “unit” may be realized by a combination of software and hardware.

The embodiments of the present invention have been described above. Some of the embodiments may be implemented in combination. Alternatively, one or some of the embodiments may be implemented partially. Specifically, only one of the ones each described as a “unit” in the description of the embodiments may be employed, or any arbitrary combination of some of the ones may be employed. The present invention is not limited to the embodiments, and various modifications can be made as necessary.

### REFERENCE SIGNS LIST

100: encoding performance evaluation support apparatus, 101: camera, 102: input interface, 103: decoder, 104: processor, 105: memory, 106: output interface, 107: display, 109: processing circuit, 110: extraction unit, 120: calculation unit, 121: argument calculation unit, 122: norm calculation unit, 130: detection unit, 140: accumulation unit, 150: computation unit, 160: output unit, 201: encoded video, 202: evaluation index, 301: norm data

1-7. (canceled)

8. An encoding performance evaluation support apparatus comprising processing circuitry:
to extract a plurality of motion vectors from an encoded video;
to calculate arguments and norms of the plurality of motion vectors extracted;
to generate from a calculation result of the arguments and norms, norm data including at least one norm for each argument, and accumulate the generated norm data in a memory; and
to output at least either of information obtained from the accumulated norm data and indicating a search range of motion vectors in the encoded video, and information obtained from the accumulated norm data and indicating search characteristics of motion vectors in the encoded video.

9. The encoding performance evaluation support apparatus according to claim 8,
wherein the processing circuitry includes, when arguments of two or more motion vectors calculated are same values, for the same values, any one norm among norms of the two or more motion vectors calculated, in the norm data, and includes, when an argument of one motion vector calculated is a different value from an argument of any other motion vector, for the different value, a norm of the one motion vector calculated, in the norm data, and
wherein the processing circuitry outputs the information indicating the search range computed from the accumulated norm data.

10. The encoding performance evaluation support apparatus according to claim 9,
wherein the processing circuitry includes, when arguments of two or more motion vectors calculated are same values, for the same values, a maximum norm among norms of the two or more motion vectors calculated, in the norm data.

11. The encoding performance evaluation support apparatus according to claim 9,
wherein the processing circuitry acquires from the memory the accumulated norm data and computes maximum values of cosine components and sine components of the plurality of motion vectors, using the acquired noun data, and
wherein the processing circuitry outputs a computation result of the maximum values, as the information indicating the search range.

12. The encoding performance evaluation support apparatus according to claim 8,
wherein the processing circuitry includes, when arguments of two or more motion vectors calculated are same values, for the same values, all norms among norms of the two or more motion vectors calculated, in the norm data, and includes, when an argument of one motion vector calculated is a different value from an argument of any other motion vector, for the different value, a norm of the one motion vector calculated, in the norm data, and
wherein the processing circuitry outputs the accumulated norm data, as the information indicating the search characteristics.

13. An encoding performance evaluation support method comprising:
extracting a plurality of motion vectors from an encoded video;
calculating arguments and norms of the plurality of motion vectors extracted;
generating from a calculation result of the arguments and norms, norm data including at least one norm for each argument, and accumulating the generated norm data in a memory; and
outputting at least either of information obtained from the accumulated norm data and indicating a search range of motion vectors in the encoded video, and information obtained from the accumulated norm data and indicating search characteristics of motion vectors in the encoded video.

14. A non-transitory computer readable medium storing an encoding performance evaluation support program to cause a computer to execute:
a process to extract a plurality of motion vectors from an encoded video;
a process to calculate arguments and norms of the plurality of motion vectors extracted;
a process to generate from a calculation result of the arguments and norms, norm data including at least one norm for each argument, and accumulate the generated norm data in a memory; and
a process to output at least either of information obtained from the norm data accumulated in the memory and indicating a search range of motion vectors in the encoded video, and information obtained from the norm data accumulated in the memory and indicating search characteristics of motion vectors in the encoded video.

15. The encoding performance evaluation support apparatus according to claim 10,
wherein the processing circuitry acquires from the memory the accumulated norm data and computes maximum values of cosine components and sine components of the plurality of motion vectors, using the acquired norm data, and
wherein the processing circuitry outputs a computation result of the maximum values, as the information indicating the search range.
